(19) United States
(12) Patent Application Publication
(10) Pub. No.: US 2026/0138629 A1
(43) Pub. Date: May 21, 2026

(54) DETECTION AND MITIGATION OF IMPLAUSIBLE DRIVER-SELECTED TRANSMISSION STATES

(71) Applicant: GM Global Technology Operations LLC, Detroit, MI (US)

(72) Inventors: Milad Jalaliyazdi, Richmond Hill (CA); Reza Zarringhalam, Whitby (CA); Kevin Gady, Saline, MI (US)

(21) Appl. No.: 18/951,041

(22) Filed: Nov. 18, 2024

(51) Int. Cl. B60W 50/12; B60W 50/00

(52) U.S. Cl. CPC B60W 50/12; B60W 50/0097; B60W 2540/10

(57) ABSTRACT

Systems, methods, and devices for predicting unintended movement of a vehicle from driver-selected transmission states and mitigating effects of the movement are described. In some aspects, this includes obtaining sensor data for the vehicle, obtaining an obstacle grid for objects in an exterior environment, generating an ego path for the vehicle using the driver-selected transmission state, predicting unintended motion of the vehicle, and taking a mitigating action that is determined to inhibit movement of the vehicle along the ego path. The sensor data includes a driver-selected transmission state of the vehicle and obstacle data for the exterior environment. The obstacle grid is obtained using the obstacle data. The predicting includes determining that the ego path does not correspond with an intended path of the vehicle using a non-selected transmission state. The mitigating action is taken in response to predicting the unintended motion.

### INTRODUCTION

The disclosure relates to the field of driver-controlled vehicles and, more specifically, to systems and methods for detecting and mitigating implausible or unintended driver-selected transmission states.

Situations exist where a vehicle may be in a driver-selected transmission state that is different to the transmission state that the driver actually desires. For example, the driver may have placed the vehicle in reverse and then, due to driver distraction or other event, fails to place the vehicle in a forward gear prior to releasing the brake. This unintended motion can lead to unintended contact between the vehicle and surrounding objects. Therefore, there is a need in the art to mitigate effects of unintended driver-selected transmission states.

### SUMMARY

Systems, methods, and devices in accordance with the present disclosure provide for predicting unintended movement from driver-selected transmission states and mitigating the effects.

The unintended movement may be predicted by detecting an unintended state of the transmission (e.g., Reverse when Drive was intended) based on the surrounding environment and/or previous driver inputs. In some aspects, the unintended movement is predicted by generating the actual path for the vehicle and comparing it with the apparent path of the vehicle based on other factors and comparing probabilities of potential contact between the vehicle and surrounding objects along those paths.

The systems, methods, and devices are configured to take one or more mitigating actions to mitigate the effects of driver-initiated unintended-movement events by alerts or prompts, bypassing driver-input control signals, and/or overriding driver-input control signals. Beneficially, mitigating or reducing the effects of driver-initiated unintended-movement events by these systems, methods, and devices optimize efficacy of inhibiting contact while enhancing comfort and security of vehicle drivers, passengers, and owners.

According to aspects of the present disclosure, a method includes obtaining sensor data for a vehicle, obtaining an obstacle grid for objects in an exterior environment that is proximate to the vehicle, generating an ego path for the vehicle using a driver-selected transmission state, predicting unintended motion of the vehicle, and taking a mitigating action that is determined to inhibit movement of the vehicle along the ego path. The sensor data is obtained using a controller of the vehicle and includes both the driver-selected transmission state of the vehicle and obstacle data for the exterior environment. The obstacle grid is obtained using the controller and the obstacle data. The ego path is generated using the controller. The unintended motion of the vehicle is predicted using the controller. The predicting includes determining that the ego path does not correspond with an intended path of the vehicle using a non-selected transmission state. The mitigating action is taken using the controller and in response to predicting the unintended motion.

According to further aspects of the present disclosure, the non-selected transmission state is an opposing transmission state, wherein actuation of an accelerator in the driver-selected transmission state would propel the vehicle in a first direction and actuation of the accelerator in the opposing transmission state would propel the vehicle in a second direction that is opposite to the first direction.

According to further aspects of the present disclosure, determining the unintended motion includes a determination that the ego path intersects an object of the obstacle grid.

According to further aspects of the present disclosure, the method further includes determining the intended path based on an available path of the vehicle for the non-selected transmission state being a prior ego path for a prior driver-selected transmission state that immediately preceded the driver-selected transmission state.

According to further aspects of the present disclosure, the mitigating action is a plurality of escalating mitigating actions.

According to further aspects of the present disclosure, predicting unintended motion of the vehicle is a determination that a probability of an incorrect transmission state exceeds a predetermined threshold, the probability of the incorrect transmission state including comparing probabilities for a plurality of driver-action metrics and a plurality of vehicle-based metrics.

According to further aspects of the present disclosure, calculating the probability of an incorrect transmission state includes a sum of weighted probabilities of the driver-action metrics and weighted probabilities of the vehicle-based metrics.

According to further aspects of the present disclosure, the driver-action metrics include transmission gear state, time since last gear shift, driver attention state, at least one driver pedal command, and driver steering angle command.

According to further aspects of the present disclosure, the vehicle-based metrics include distance to at least one obstacle grid, proximity of the ego path to a respective one or more of the at least one obstacle grids, proximity of available paths to a respective one or more of the at least one obstacle grids, a speed of the vehicle, surface indicia around the vehicle, and history of motion of the vehicle.

According to aspects of the present disclosure, a system includes a controller with a processor and instructions that, when executed, cause the system to obtain sensor data for a vehicle, obtain an obstacle grid for objects in an exterior environment that is proximate to the vehicle, generate an ego path for the vehicle using a driver-selected transmission state, predict unintended motion of the vehicle, and take a mitigating action that is determined to inhibit movement of the vehicle along the ego path. The sensor data is obtained using a controller of the vehicle and includes both the driver-selected transmission state of the vehicle and obstacle data for the exterior environment. The obstacle grid is obtained using the controller and the obstacle data. The ego path is generated using the controller. The unintended motion of the vehicle is predicted using the controller. The predicting includes determining that the ego path does not correspond with an intended path of the vehicle using a non-selected transmission state. The mitigating action is taken using the controller and in response to predicting the unintended motion.

According to further aspects of the present disclosure, the non-selected transmission state is an opposing transmission state, wherein actuation of an accelerator in the driver-selected transmission state would propel the vehicle in a first direction and actuation of the accelerator in the opposing transmission state would propel the vehicle in a second direction that is opposite to the first direction.

According to further aspects of the present disclosure, determining the unintended motion includes a determination that the ego path intersects an object of the obstacle grid.

According to further aspects of the present disclosure, the system further including determining the intended path based on an available path of the vehicle for the non-selected transmission state being a prior ego path for a prior driver-selected transmission state that immediately preceded the driver-selected transmission state.

According to further aspects of the present disclosure, predicting unintended motion of the vehicle is a determination that a probability of an incorrect transmission state exceeds a predetermined threshold, the probability of the incorrect transmission state including comparing probabilities for a plurality of driver-action metrics and a plurality of vehicle-based metrics.

According to further aspects of the present disclosure, calculating the probability of an incorrect transmission state includes a sum of weighted probabilities of the driver-action metrics and weighted probabilities of the vehicle-based metrics.

According to further aspects of the present disclosure, the driver-action metrics include transmission gear state, time since last gear shift, driver attention state, at least one driver pedal command, and driver steering angle command.

According to further aspects of the present disclosure, the vehicle-based metrics include distance to at least one obstacle grid, proximity of the ego path to a respective one or more of the at least one obstacle grids, proximity of available paths to a respective one or more of the at least one obstacle grids, a speed of the vehicle, surface indicia around the vehicle, and history of motion of the vehicle.

According to aspects of the present disclosure, a vehicle includes a controller with a processor and instructions that, when executed, cause the vehicle to obtain sensor data for the vehicle, obtain an obstacle grid for objects in an exterior environment that is proximate to the vehicle, generate an ego path for the vehicle using a driver-selected transmission state, predict unintended motion of the vehicle, and take a mitigating action that is determined to inhibit movement of the vehicle along the ego path. The sensor data is obtained using a controller of the vehicle and includes both the driver-selected transmission state of the vehicle and obstacle data for the exterior environment. The obstacle grid is obtained using the controller and the obstacle data. The ego path is generated using the controller. The unintended motion of the vehicle is predicted using the controller. The predicting includes determining that the ego path does not correspond with an intended path of the vehicle using a non-selected transmission state. The mitigating action is taken using the controller and in response to predicting the unintended motion.

According to further aspects of the present disclosure, predicting unintended motion of the vehicle is a determination that a probability of an incorrect transmission state exceeds a predetermined threshold, the probability of the incorrect transmission state including comparing probabilities for a plurality of driver-action metrics and a plurality of vehicle-based metrics, and wherein calculating the probability of an incorrect transmission state includes a sum of weighted probabilities of the driver-action metrics and weighted probabilities of the vehicle-based metrics.

According to further aspects of the present disclosure, the driver-action metrics include transmission gear state, time since last gear shift, driver attention state, at least one driver pedal command, and driver steering angle command and wherein the vehicle-based metrics include distance to at least one obstacle grid, proximity of the ego path to a respective one or more of the at least one obstacle grids, proximity of available paths to a respective one or more of the at least one obstacle grids, a speed of the vehicle, surface indicia around the vehicle, and history of motion of the vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIGS. 1A-1E illustrate an example situation of a vehicle in an unintended transmission state, according to some aspects of the present disclosure;

FIG. 2 illustrates an Advanced Driver Assistance System employed by the vehicle, according to aspects of the present disclosure;

FIG. 3 illustrates a first method for mitigating an unintended transmission state of the vehicle, according to aspects of the present disclosure; and

FIG. 4 illustrates a second method for mitigating an unintended transmission state of the vehicle, according to aspects of the present disclosure.

### DETAILED DESCRIPTION

The following detailed description is merely exemplary in nature and is not intended to limit the application and uses. Furthermore, there is no intention to be bound by expressed or implied theory presented in the preceding introduction, summary, or brief description of the drawings or the following detailed description.

As used herein, the term “module” refers to hardware, software, firmware, electronic control component, processing logic, and/or processor device, individually or in a combination thereof, including without limitation: an application specific integrated circuit (ASIC), an electronic circuit, a processor (shared, dedicated, or group) and memory that executes one or more software or firmware programs, a combinational logic circuit, and/or other components that provide the described functionality.

Embodiments of the present disclosure may be described herein in terms of functional and/or logical block components and various processing steps. It should be appreciated that such block components may be realized by one or more hardware, software, and/or firmware components configured to perform the specified functions. For example, embodiments of the present disclosure may employ various integrated circuit components (e.g., memory elements, digital signal processing elements, logic elements, look-up tables, or the like), which may carry out a variety of functions under the control of one or more microprocessors or other control devices. In addition, those skilled in the art will appreciate that embodiments of the present disclosure may be practiced in conjunction with one or more systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in embodiments of the present disclosure.

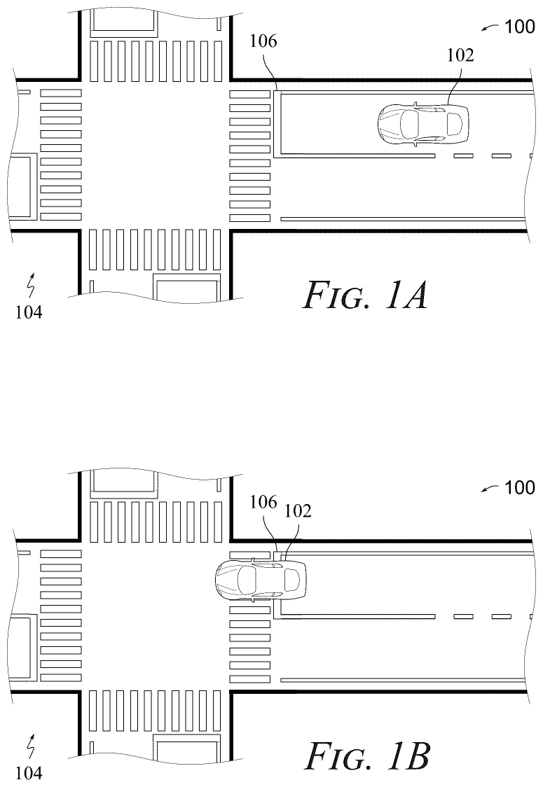

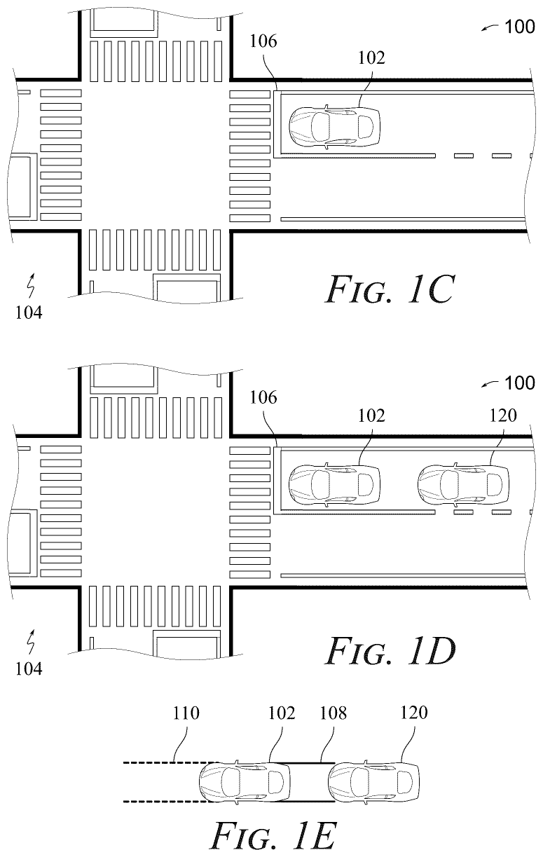

FIGS. 1A-1E illustrate an example situation 100 of a vehicle 102 in an unintended transmission state.

FIG. 1A illustrates the vehicle 102 approaching an intersection 104 with a traffic control device (not illustrated). In the illustrated example, the driver does not receive and/or react to the signal from the traffic control device in an adequate amount of time.

FIG. 1B illustrates the vehicle 102 after coming to a complete stop. As can be seen, the vehicle 102 has come to a complete stop beyond the stop line 106. To correct this, the driver changes the transmission state into reverse and maneuvers the vehicle 102 backwards so that the vehicle 102 is properly positioned within the lane and behind the stop line 106.

FIG. 1C, illustrates the vehicle 102 after having reversed into the proper position within the lane and behind the stop line 106. While the vehicle 102 is properly positioned behind the stop line 106, the driver has not shifted the vehicle 102 into drive.

In FIG. 1D, a second vehicle 120 has approached and stopped behind the first vehicle 102.

FIG. 1E, is an isolated view of the first vehicle 102 and the second vehicle 120 with the ego path 108 and intended path 110 illustrated. As can be seen, because the vehicle 102 is still in reverse, the ego path 108 is behind the vehicle 102 while the intended path 110 is in front of the vehicle 102. Notably, the ego path 108 intersects with the second vehicle 120 while the intended path 110 is open.

Beneficially, the vehicle 102 is configured to mitigate the unintended transmission state by taking one or more mitigating actions. The one or more mitigating actions may be, for example, an alert to the mismatch or active measures.

Alerts may include, for example, a visual indication, an audial indication, a haptic indication, combinations thereof, and the like. The visual indication may be communicated via a digital screen or a heads-up display within the vehicle 102. The audial indication may be communicated via a sound system of the vehicle 102. The haptic indication may come from a vehicle component with which the driver is in contact. The vehicle component may be, for example, the steering wheel or driver seat.

Active measures may include, for example, altering an input, bypassing an input, or overriding an input.

Altering an input may include, for example, reducing or increasing a response of the vehicle 102 to an input by the driver. For example, if the vehicle 102 senses that the driver has released the brake by a predetermined amount, the vehicle 102 may allow itself to move backward slightly and actuate the brake at the current pedal position as an indication to the driver that they remain in reverse. Similarly, if the vehicle 102 senses that the driver has released the brake, began moving backward, and then reapplied the brake, the vehicle 102 may increase actuation of the brakes.

Bypassing an input may include ignoring a change in the input. For example, if the driver releases the brake pedal, the vehicle 102 may ignore the brake pedal release and continue actuating the brakes until the incorrect transmission state is corrected. In an additional or alternative example, if the driver depresses the accelerator pedal, the vehicle 102 may ignore the accelerator command and display an alert message until the incorrect transmission state is corrected or an additional driver input indicates the transmission state is correct. The additional driver input may be, for example, releasing and re-actuating the accelerator pedal in response to the message, dismissing the message without changing the transmission state, quickly shifting out of and then returning to the current transmission state, combinations thereof, and the like.

Overriding an input may include applying a corrective control action. For example, if the driver releases the brake pedal and depresses the accelerator pedal, the vehicle 102 may ignore the accelerator input at a predetermined point and reapply the brakes until the incorrect transmission state is corrected.

The mitigating actions may also be issued as escalating actions based on the probability of mismatch and/or the effectiveness of issued mitigating actions. For example, the vehicle 102 may begin by issuing an alert, then may bypass inputs if the alert is insufficient to correct the transmission state, and then may override inputs if the bypass is insufficient to correct the transmission state.

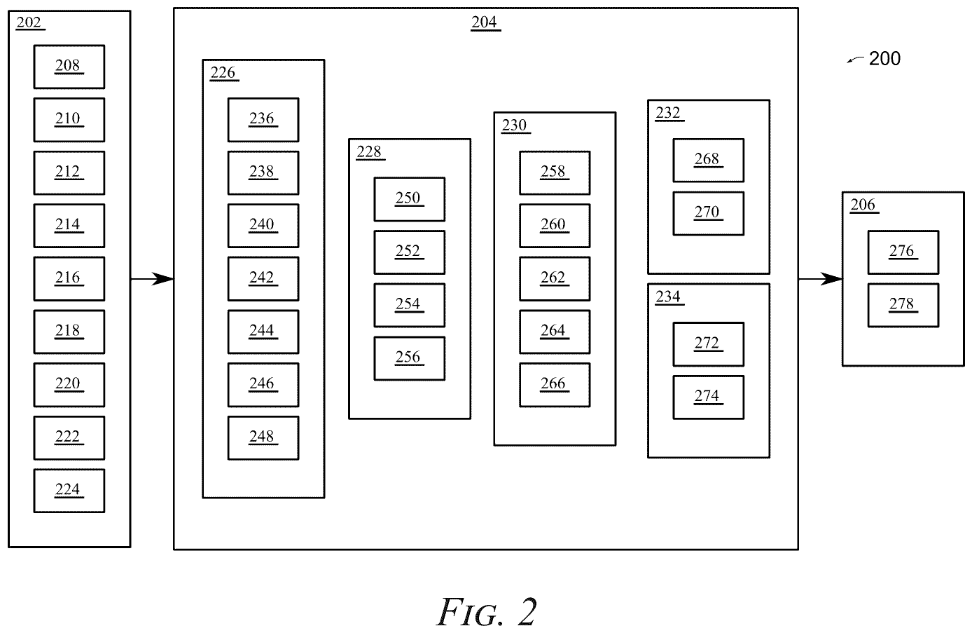

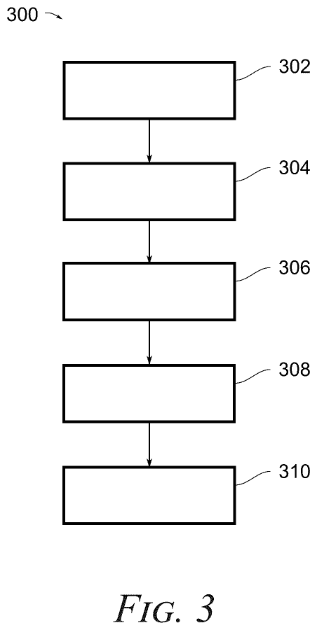

FIG. 2 illustrates an Advanced Driver Assistance System (“ADAS”) 200, according to aspects of the present disclosure. The ADAS 200 includes a plurality of inputs 202, an ADAS controller 204, and a plurality of ADAS outputs 206.

Each of the plurality of inputs 202 is configured to obtain information for use by the ADAS controller 204. The inputs 202 may include, for example, sensors and data. The sensors are configured to detect and signal conditions related to physical environments. The data may include, for example, data stored by the vehicle 102 or obtained via a data connection to the vehicle 102. In the illustrated example, the sensor inputs 202 include driver input sensors 208, touch sensors 210, driver customizations 212, transmission state sensors 214, driver monitoring system (“DMS”) data 216, roadway information 218, object-detection sensors 220, telematic sensors 222, and vehicle dynamics sensors 224.

The driver input sensors 208 are configured to provide information about driver inputs related to driving the vehicle 102. The driver inputs may include, for example, a steering wheel position, a wheel position, a brake input, an accelerator position, combinations thereof, and the like.

The touch sensors 210 are configured to provide touch information from devices of the vehicle 102. The touch information may include information related to user interaction with, for example, a touchscreen device, instruments in the cabin, combinations thereof, and the like.

The driver customizations 212 provide information related to the particular driver of the vehicle 102. The driver customizations 212 may include, for example, changes to vehicle setting by or for the driver.

The transmission state sensors 214 are configured to provide information about the state of the transmission. The information about the state of the transmission may include, for example, the current transmission state, historical transmission states, times related thereto, combinations thereof, and the like.

The DMS data 216 includes information collected and/or provided information related to the state of the driver. The information related to the state of the driver may include, for example, alertness, awareness, gaze, position, posture, fatigue, combinations thereof, and the like.

The roadway information 218 is configured to provide roadway environment information for use by the ADAS controller 204. The roadway environment information may include, for example, roadway markings, lane information, traffic control device availability, traffic control device state, combinations thereof, and the like.

The object-detection sensors 220 are configured to detect or provide object information for the environment around the vehicle 102. The object information may include, for example, grid maps, tracking information, distance information, direction information, orientation information, classification information, combinations thereof, and the like.

The telematic sensors 222 are configured to provide telematic information to the ADAS controller 204 via communication with remote devices. The telematic information may include, for example, GPS data, mapping data, route data, position data, speed data, acceleration data, combinations thereof, and the like.

The vehicle dynamics sensors 224 are configured to provide vehicle dynamics information related to the motion of the vehicle 102. The vehicle dynamic information may include, for example, heading, speed, acceleration, inclination, wheelbase, steering geometry, steering ratio, bump steer, combinations thereof, and the like.

The ADAS controller 204 is configured to assist in operating the vehicle 102 based on received inputs 202 using one or more outputs 206. The ADAS controller 204 may be, for example, a programmable controller or electronic control module. The programmable controller or electronic control module may be one or more microprocessors, such as a central processing unit (CPU) or graphics processing unit (GPU), in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle 102.

The illustrated ADAS controller 204 includes an input interface 226, an environment processing component 228, a prediction component 230, a Human Machine Interface (“HMI”) output interface 232, and a vehicle control output interface 234.

The input interface 226 is configured to receive information from the inputs 202 and transfer it to other components of the ADAS controller 204. In the illustrated example, the input interface 226 includes a pedal-input ingestor 236, a steering-input ingestor 238, a turn signal switch input ingestor 240, a driver attention ingestor 242, a vehicle path prediction ingestor 244, an object fusion ingestor 246, and a lane fusion ingestor 248.

The pedal-input ingestor 236 is configured to intake data related to pedal inputs of the vehicle 102. The pedal inputs may include, for example, displacement and time information.

The steering-input ingestor 238 is configured to intake data related to steering inputs of the vehicle 102. The steering inputs may include, for example, angle of the steering wheel, positions of steering actuators, torque of or resistance to the inputs, time of inputs, and the like.

The turn signal switch input ingestor 240 is configured to intake data related to the state of the turn signal switch (e.g., positioned to indicate left, to indicate right, or in a neutral position).

The driver attention ingestor 242 is configured to intake data related to a driver state, such as the state determined using the DMS data 216.

The vehicle path prediction ingestor 244 is configured to intake data related to a predicted vehicle path, for example, a predicted vehicle path determined by a component of the ADAS controller 204, the vehicle 102, or a remote device.

The object fusion ingestor 246 is configured to intake object data collected by multiple sensors. The intake object data may be received in a fused state, received in a raw state and fused by the object fusion ingestor 246, passed to another component of the ADAS controller 204, or combinations thereof.

The lane fusion ingestor 248 is configured to intake lane data collected by multiple sensors. The intake lane data may be received in a fused state, received in a raw state and fused by the object fusion ingestor 246, passed to another component of the ADAS controller 204, or combinations thereof.

The environment processing component 228 is configured to process information and make determinations about the environment of the vehicle 102. In the illustrated example, the environment processing component 228 includes an enablement condition validator 250, an obstacle grid generator 252, an object heat map generator 254, and a traffic device state processing component 256.

The enablement condition validator 250 is configured to validate the state of conditions that are needed to enable use of the ADAS controller 204 or components thereof. The conditions may include, for example, state of one or more user settings, presence of particular sensors and/or particular sensor data, operating conditions of the vehicle 102, vehicle environment, combinations thereof, and the like.

The obstacle grid generator 252 is configured to process data and generate a grid of detected obstacles for use in determining drivable space for the vehicle 102. The obstacle grid generator may generate, for example, an ego-centric grid and/or geo-centric grid. The ego-centric grid is generated with respect to the vehicle 102 and may be adapted to environmental features and host-vehicle dynamics. The geo-centric grid is environment dependent and may be generated based on the environment of the host-vehicle, such as an intersection or parking lot. The environment may be determine using, for example, vehicle sensors or telematic devices. After establishing grid-cell boundaries, detected objects may be assigned to the corresponding cells.

The object heat map generator 254 is configured to process data and generate a heat map of objects detected in the external environment. The heat map may include, for example distance and height data for measurements around the vehicle 102 taken via sensors. This data may be used by the obstacle grid generator 252 or fused with the obstacle grid by the object heat map generator 254 or another component. In some aspects, the sensors are LiDAR sensors.

The traffic device state processing component 256 is configured to process data related to the state of traffic devices. The data may include data of the traffic device obtained by vehicle sensors, historical information, data obtained from the traffic device, data obtained from other vehicles, combinations thereof, and the like.

The prediction component 230 is configured to make a prediction about the state of the transmission. In the illustrated example, the prediction component 230 includes an actual trajectory predictor 258, an apparent trajectory predictor 260, a plausible trajectory generator 262, a contact assessor 264, and an intention mismatch determiner 266.

The actual trajectory predictor 258 is configured to determine the trajectory of the vehicle 102 (e.g., the ego path 108) when accelerated. The actual trajectory predictor 258 may use the based on the current transmission state of the vehicle 102.

The apparent trajectory predictor 260 is configured to determine one or more driver-intended trajectories of the vehicle 102. The apparent trajectory predictor 260 uses one or more non-selected transmission states as well as other sensed data to make the determination.

In some aspects, the apparent trajectory predictor 260 uses a non-selected transmission state that is based on the driver-selected transmission state. For example, the non-selected transmission state may be drive when the driver-selected transmission state is reverse, reverse when the driver-selected transmission state is drive, and/or park when the driver-selected transmission state is neutral.

In some aspects, the apparent trajectory predictor 260 uses a non-selected transmission state based on last transmission state prior to the current transmission state. For example, the non-selected transmission state may be drive when the current state is neutral and the last state was reverse.

In some aspects, the apparent trajectory predictor 260 uses a non-selected transmission state that is based on a location of the vehicle. For example, the non-selected transmission state may be park when the current transmission state is reverse and the vehicle 102 has just driven into a known parking spot. The location may be sensed through object detection devices, telematic devices, a lack thereof, combinations thereof, and the like.

The plausible trajectory generator 262 is configured to determine one or more paths plausible paths that the vehicle 102 may take based on outputs of the apparent trajectory predictor 260 (e.g., the intended path 110) and/or the actual trajectory predictor 258 (e.g., the ego path 108).

The contact assessor 264 is configured to determine a probability that the vehicle 102 traveling along a path (e.g., the ego path 108 and the intended path 110) will come into contact with a detected object (e.g., objects within one or more of the generated object grids).

The intention mismatch determiner 266 is configured to determine a misalignment between the ego path 108 and the intended path 110 due to an incorrect transmission state.

The intention mismatch determiner 266 determines a probability of misalignment using probabilities for a plurality of driver-action metrics and a plurality of vehicle-based metrics. In some aspects, the probability of unintended motion is determined using a sum of weighted probabilities of the driver-action metrics and weighted probabilities of the vehicle-based metrics using, for example, the following equation:

$$P = \sum {W}_{d} {P}_{d} + {W}_{s} {P}_{s}$$

where:
W_{d} is weighing factors for the driver-action metric probabilities;
P_{d} is probabilities for driver-action metrics;
Wₛ is weighing factors for the vehicle-based metric probabilities; and
Pₛ is probabilities for vehicle-based metrics.

The driver-action metrics include metrics based on particular actions of the driver. For example, the driver-action metrics may include, for example, a transmission gear state s_{g}, time since last gear shift t_{g}, driver attention state e_{d}, eye gaze duration in the direction of the selected gear tₑ, accelerator pedal command aa, brake pedal command b_{d}, steering angle command δ_{d}, combinations thereof, and the like. The probabilities of these may be represented by the following equation:

$${P}_{d} = [ ]$$

where each element is a function for the effect of each respective variable on the probability. The functions may be individually weighted by the following equation:

$${W}_{d} = [ \begin{matrix}{w}_{{d}_{1}} & {w}_{{d}_{2}} & … & {w}_{{d}_{m}}\end{matrix} ]$$

where each element is a scalar weight of its respective probability.

In some aspects, the driver-action metrics include a transmission gear state s_{g}, time since last gear shift t_{g}, a steering angle command δ_{d}, driver attention state e_{d}, and at least one of an accelerator pedal command a_{d} and brake pedal command b_{d}.

The vehicle-based metrics include metrics based on the state and history of the vehicle 102, such as scene, motion, and object metrics. The vehicle-based metrics may include, for example, distances to obstacle grids in front of the vehicle d_{of}, distances to obstacle grids behind the vehicle dₒᵣ, proximity of apparent trajectory to front objects d_{pf}, proximity of apparent trajectory to rear objects dₚᵣ, proximity of actual trajectory to front objects d_{af}, proximity of actual trajectory to rear objects dₐᵣ, vehicle speed vₓ, distance to road markings in front of the vehicle d_{rf}, distance to road markings behind the vehicle dᵣᵣ, road marking states sᵣ, distance to traffic control devices in front of vehicle d_{tf}, distance to traffic control devices behind the vehicle dₜᵣ, traffic control device status sₜ, history of traffic device status changes hₜₛ, history of host vehicle motion hₘ, combinations thereof, and the like. The probabilities of these may be represented by the following equation:

$${P}_{s} = [ ]$$

where each element is a function for the effect of each respective variable on the probability. The functions may be individually weighted by the following equation:

$${W}_{s} = [ \begin{matrix}{w}_{{s}_{1}} & {w}_{{s}_{2}} & … & {w}_{{s}_{m}}\end{matrix} ]$$

where each element is a scalar weight of its respective probability.

In some aspects, distance to at least one obstacle grid, proximity of the ego path to a respective one or more of the at least one obstacle grids, proximity of available paths to a respective one or more of the at least one obstacle grids, the speed of the vehicle vₓ, surface indicia around the vehicle, and history of host vehicle motion hₘ.

The HMI output interface 232 is configured to output information to an interface system that allows an operator to view messages, issue commands, enter information, or otherwise provide input to the system. In the illustrated example, the HMI output interface 232 includes a notification controller 268 and an HMI request controller 270.

The notification controller 268 is configured to generate notifications for display to the driver. The notifications may be visual notifications, audial notifications, haptic notifications, combinations thereof, and the like. The visual notifications may be presented to the driver using a screen or display of the vehicle 102. The audial notifications may be presented to the driver using the sound system of the vehicle 102 or a connected audio device (e.g., a driver's hearing aids). The haptic notifications may be presented to the driver using surfaces with which the driver is in contact, such as the steering wheel or the seat.

The HMI request controller 270 is configured to manage driver-issued commands, information, or input to the system in response to an action of the system. The HMI request controller 270 may be, for example, an electronic controller that processes a driver input dismissing a prompt issued by the system or a driver-control action that is intentionally different from the system's action. In some aspects, an indication that a driver-control action is intentionally different from the system action may be, in response to a prompt indicating the wrong transmission state, the driver releasing the brake pedal, moving the vehicle 102 slightly backward, reapplying the brake, and leaving the gearshift in the current position.

The vehicle control output interface 234 is configured to output control signals to a vehicle control system that can actuate, for example, a propulsion system, transmission system, steering system, and braking system of the vehicle 102. In the illustrated example, the vehicle control output interface 234 includes a steering control unit 272 and a propulsion control unit 274.

The steering control unit 272 is configured to manage a steering system of the vehicle 102. For example, the steering control unit 272 may be an electronic control module that manages the steering system by actuating a steering action in response to receiving a steering command, determining steering actions to be taken in response to steering command inputs, communicating states of steering system components, and the like.

The propulsion control unit 274 is configured to manage a propulsion system of the vehicle 102. For example, the propulsion control unit 274 may be an electronic control module that manages the propulsion system by actuating acceleration in response to an accelerator input, determining acceleration actions to be taken in response to accelerator control inputs, receive notification of states of related systems (e.g., braking systems), communicating states of propulsion system components, and the like.

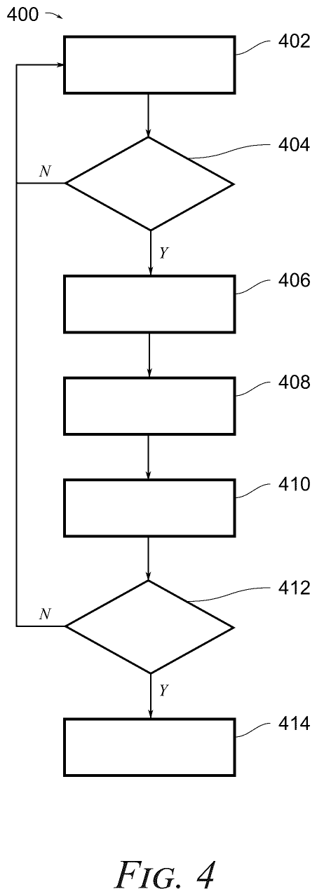

FIG. 3 illustrates a method 300 for mitigating an unintended transmission state of the vehicle 102. At block 302, the method 300 obtains sensor data for the vehicle 102. The sensor data includes a driver-selected transmission state and obstacle data. The driver-selected transmission state is the contemporaneous setting of the vehicle 102. The obstacle data includes indicia of obstacles in an environment of the exterior of the vehicle 102. The sensor data may be obtained using at least one controller of the vehicle 102.

At block 304, the method 300 obtains an obstacle grid for objects in the exterior environment. The vehicle 102 may use at least one controller to determine or update the obstacle grid using the obtained object data. At block 306, the method 300 generates the ego path 108 for the vehicle 102 using the driver-selected transmission state.

At block 308, the method 300 predicts unintended motion of the vehicle 102. including determining the ego path does not align with an intended path of the vehicle 102 using a non-selected transmission state. The unintended motion may be predicted using at least one controller of the vehicle 102.

At block 310, the method 300 takes a mitigating action that is determined to inhibit movement of the vehicle 102 along the ego path. The mitigating action may be taken using at least one controller of the vehicle 102.

FIG. 4 illustrates a second method 400 for mitigating an unintended transmission state of the vehicle 102. At block 402, the method 400 initializes with a state of the vehicle 102.

At decision 404, the method 400 determines whether the state provides conditions that enable continuation of the method 400. If the enabling conditions are not met, the method 400 returns to block 402. If the enabling conditions are met, then the method 400 continues to block 406.

At block 406, the method 400 obtains object information from sensors of the vehicle 102. At block 408, the method 400 generates a map of obstacles around the vehicle using the obtained object information.

At block 410, the method 400 generates vehicle paths using a plurality of transmission states for the vehicle. The transmission states include a first transmission state and a second transmission state. The first transmission state is a current transmission state, and the second transmission state is a non-selected transmission state. In some aspects, the non-selected transmission state is the transmission state that opposes the propulsion direction of the current transmission state (e.g., forward versus reverse). In some aspects, the non-selected transmission state is a transmission state from an adjacent position on the selector (e.g., “neutral” if the current state is “drive” for a PRNDL selector).

At decision 412, the method 400 determines whether to take an action to mitigate an unintended motion of the vehicle 102. The determination is made based on the probability of unintended motion exceeding a predetermined threshold.

At block 414, the method 400 takes the mitigating action. The mitigating action may be taken using at least one controller of the vehicle 102.

The misalignment of the ego path 108 and intended path 110 may be actively corrected (e.g., through user interaction with a prompt) or passively corrected (e.g., through continued monitoring that determines the probability of misalignment between the ego path 108 and the intended path 110 has fallen below a second predetermined threshold). The second predetermined threshold may be the same as the first predetermined threshold that was used to trigger the mitigating action. In some aspects, the second predetermined threshold is higher than the first predetermined threshold.

While FIGS. 1A-1E are made with reference to a roadway scenario, it is contemplated that the vehicle 102 may take one or more mitigating actions to mitigate the unintended transmission state in a parking scenario. For example, if the vehicle 102 enters a parking space, but is not placed in park because the driver is distracted, the vehicle 102 may detect the unintended transmission state and take a mitigating action to inhibit the vehicle idling forward or backward towards objects.

The condition may be detected using, for example, a history of driver attention obtained via the DMS, a location determined by vehicle sensors or telematic devices, seatbelt sensors, driver movement and pose, state of vehicle doors, combinations thereof, and the like. The mitigating action may be to lock the brakes, provide notifications, and/or inhibit vehicle shut down until the vehicle 102 is placed in park.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover modifications, equivalents, combinations, sub-combinations, permutations, groupings, and alternatives falling within the scope and spirit of the disclosure and as defined by the appended claims.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

Numerical values of parameters (e.g., of quantities or conditions) in this specification, unless otherwise indicated expressly or clearly in view of the context, including the appended claims, are to be understood as being modified by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the best modes for carrying out the disclosure have been described in detail, those familiar with the art to which this disclosure relates will recognize various alternative designs and embodiments for practicing the disclosure within the scope of the appended claims.

What is claimed is:

1. A method comprising:
obtaining, using a controller of a vehicle, sensor data for the vehicle, the sensor data including a driver-selected transmission state of the vehicle and obstacle data for an exterior environment that is proximate to the vehicle;
obtaining, using the controller and the obstacle data, an obstacle grid for objects in the exterior environment;
generating, using the controller, an ego path for the vehicle using the driver-selected transmission state;
predicting, using the controller, unintended motion of the vehicle including determining the ego path does not correspond with an intended path of the vehicle using a non-selected transmission state; and
taking, using the controller and in response to predicting the unintended motion, a mitigating action that is determined to inhibit movement of the vehicle along the ego path.

2. The method of claim 1, wherein the non-selected transmission state is an opposing transmission state, wherein actuation of an accelerator in the driver-selected transmission state would propel the vehicle in a first direction and actuation of the accelerator in the opposing transmission state would propel the vehicle in a second direction that is opposite to the first direction.

3. The method of claim 1, wherein determining the unintended motion includes a determination that the ego path intersects an object of the obstacle grid.

4. The method of claim 1, further comprising determining the intended path based on an available path of the vehicle for the non-selected transmission state being a prior ego path for a prior driver-selected transmission state that immediately preceded the driver-selected transmission state.

5. The method of claim 1, wherein the mitigating action is a plurality of escalating mitigating actions.

6. The method of claim 1, wherein predicting unintended motion of the vehicle is a determination that a probability of an incorrect transmission state exceeds a predetermined threshold, the probability of the incorrect transmission state including comparing probabilities for a plurality of driver-action metrics and a plurality of vehicle-based metrics.

7. The method of claim 6, wherein calculating the probability of an incorrect transmission state includes a sum of weighted probabilities of the driver-action metrics and weighted probabilities of the vehicle-based metrics.

8. The method of claim 7, wherein the driver-action metrics include transmission gear state, time since last gear shift, driver attention state, at least one driver pedal command, and driver steering angle command.

9. The method of claim 8, wherein the vehicle-based metrics include distance to at least one obstacle grid, proximity of the ego path to a respective one or more of the at least one obstacle grids, proximity of available paths to a respective one or more of the at least one obstacle grids, a speed of the vehicle, surface indicia around the vehicle, and history of motion of the vehicle.

10. A system comprising:
a controller including a processor and instructions that, when executed, cause the system to:
obtain sensor data for a vehicle, the sensor data including a driver-selected transmission state of the vehicle and obstacle data for an exterior environment that is proximate to the vehicle;
obtain, using the obstacle data, an obstacle grid for objects in the exterior environment;
generate an ego path for the vehicle using the driver-selected transmission state;
predict unintended motion of the vehicle including determining the ego path does not correspond with an intended path of the vehicle using a non-selected transmission state; and
take, in response to predicting the unintended motion, a mitigating action that is determined to inhibit movement of the vehicle along the ego path.

11. The system of claim 10, wherein the non-selected transmission state is an opposing transmission state, wherein actuation of an accelerator in the driver-selected transmission state would propel the vehicle in a first direction and actuation of the accelerator in the opposing transmission state would propel the vehicle in a second direction that is opposite to the first direction.

12. The system of claim 10, wherein determining the unintended motion includes a determination that the ego path intersects an object of the obstacle grid.

13. The system of claim 10, further comprising determining the intended path based on an available path of the vehicle for the non-selected transmission state being a prior ego path for a prior driver-selected transmission state that immediately preceded the driver-selected transmission state.

14. The system of claim 10, wherein predicting unintended motion of the vehicle is a determination that a probability of an incorrect transmission state exceeds a predetermined threshold, the probability of the incorrect transmission state including comparing probabilities for a plurality of driver-action metrics and a plurality of vehicle-based metrics.

15. The system of claim 14, wherein calculating the probability of an incorrect transmission state includes a sum of weighted probabilities of the driver-action metrics and weighted probabilities of the vehicle-based metrics.

16. The system of claim 15, wherein the driver-action metrics include transmission gear state, time since last gear shift, driver attention state, at least one driver pedal command, and driver steering angle command.

17. The system of claim 16, wherein the vehicle-based metrics include distance to at least one obstacle grid, proximity of the ego path to a respective one or more of the at least one obstacle grids, proximity of available paths to a respective one or more of the at least one obstacle grids, a speed of the vehicle, surface indicia around the vehicle, and history of motion of the vehicle.

18. A vehicle comprising:
a controller including a processor and instructions that, when executed, cause the vehicle to:
obtain sensor data for the vehicle, the sensor data including a driver-selected transmission state of the vehicle and obstacle data for an exterior environment that is proximate to the vehicle;
obtain, using the obstacle data, an obstacle grid for objects in the exterior environment;
generate an ego path for the vehicle using the driver-selected transmission state;
predict unintended motion of the vehicle including determining the ego path does not correspond with an intended path of the vehicle using a non-selected transmission state; and
take, in response to predicting the unintended motion, a mitigating action that is determined to inhibit movement of the vehicle along the ego path.

19. The vehicle of claim 18, wherein predicting unintended motion of the vehicle is a determination that a probability of an incorrect transmission state exceeds a predetermined threshold, the probability of the incorrect transmission state including comparing probabilities for a plurality of driver-action metrics and a plurality of vehicle-based metrics, and wherein calculating the probability of an incorrect transmission state includes a sum of weighted probabilities of the driver-action metrics and weighted probabilities of the vehicle-based metrics.

20. The vehicle of claim 19, wherein the driver-action metrics include transmission gear state, time since last gear shift, driver attention state, at least one driver pedal command, and driver steering angle command and wherein the vehicle-based metrics include distance to at least one obstacle grid, proximity of the ego path to a respective one or more of the at least one obstacle grids, proximity of available paths to a respective one or more of the at least one obstacle grids, a speed of the vehicle, surface indicia around the vehicle, and history of motion of the vehicle.
